(19) United States
(12) Patent Application Publication
(10) Pub. No.: US 2025/0291174 A1
(43) Pub. Date: Sep. 18, 2025

(54) DOUBLE-PASS FIELD-OF-VIEW (FOV) EXPANDER FOR A MICRO-ELECTROMECHANICAL SYSTEMS (MEMS)-BASED SCANNING SYSTEM

(71) Applicant: Meta Platforms Technologies, LLC, Menlo Park, CA (US)

(72) Inventors: Youmin WANG, Bellevue, WA (US); Michael TILLEMAN, Redmond, WA (US); Ruiting HUANG, Kenmore, WA (US)

(73) Assignee: Meta Platforms Technologies, LLC, Menlo Park, CA (US)

(21) Appl. No.: 19/057,558

(22) Filed: Feb. 19, 2025

Related U.S. Application Data
(60) Provisional application No. 63/564,813, filed on Mar. 13, 2024.

(51) Int. Cl. G02B 26/08; G02B 26/10

(52) U.S. Cl. CPC G02B 26/0833; G02B 26/105

(57) ABSTRACT

Augmented and/or virtual reality (AR/VR), near-eye display devices that implement eye tracking are disclosed. In examples, an eye tracking system for an augmented reality (AR)/virtual reality (VR) display device includes a light source to emit an incident light beam in a first direction, a fisheye lens to propagate the incident light beam in the first direction, and a micro-electromechanical systems (MEMS) mirror to pivot from a first position to a second position to reflect the incident light beam in a second direction to enable angular amplification and scanning of a field-of-view (FOV).

### PRIORITY

The present application claims priority to U.S. provisional patent application Ser. No. 63/564,813, filed on Mar. 13, 2024, which is incorporated by reference in its entirety.

### TECHNICAL FIELD

This provisional patent application relates generally to augmented reality (AR) and/or virtual reality (VR) near-eye display devices, and in particular, to a double-pass field-of-view (FOV) expander for a micro-electromechanical systems (MEMS)-based scanning system.

### BACKGROUND

Currently, eye tracking system types may include scanning-based systems and camera-based systems. In some instances, camera-based systems may not always offer high-speed imaging rates at low cost, and may draw significantly from a system's total available power.

Alternatively, a scanning-based system may offer fast scanning speeds, dynamic laser intensity control, and smaller profiles (e.g., in size, weight, and power). Nevertheless, in some instances, scanning-based systems may also come with drawbacks. For example, typically, a scanning-based system may only collect specular and diffuse scattered light reflected from a user's eye, which may not be sufficient to facilitate high tracking accuracy and precision. Also, in some instances, scanning-based systems may offer limited field-of-view (FOV), limited resolution, and incident angle-caused field distortion.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality (AR) system environment including a near-eye display, according to an example.

FIGS. 2A-2C, respectively, illustrate various views of a near-eye display device in the form of a head-mounted display (HMD) device, according to examples.

FIG. 3 illustrates a perspective view of a near-eye display in the form of a pair of glasses, according to an example.

FIG. 4 illustrates a display system having an afocal fisheye lens with a micro-electromechanical system (MEMS) mirror, according to an example.

FIG. 5 illustrates a display system having an afocal fisheye lens with a micro-electromechanical system (MEMS) mirror, according to an example.

FIG. 6 illustrates a display system having an afocal fisheye lens with a micro-electromechanical system (MEMS) mirror, according to an example.

FIG. 7 illustrates a method for implementing a display system having an afocal fisheye lens with a micro-electromechanical system (MEMS) mirror, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Many augmented reality (AR) and virtual reality (VR) devices implement eye-tracking. For example, in some instances, these technologies may be utilized to perform eye-tracking to monitor a user's “gaze” during use of a device.

Currently, eye tracking systems may include scanning-based systems and camera-based systems. In some examples, camera-based systems may not (typically) reach high-speed imaging rates (e.g., exceeding five-hundred (500) frames per second (fps)) with relatively low cost. Moreover, in some instances, camera-based systems may rely on illumination by multiple light-emitting diodes (LEDs), which may draw significantly from a system's total power consumption.

In some examples, a scanning-based system may offer fast scanning speeds, dynamic laser intensity control, and smaller profiles (e.g., in size, weight, and power). Nevertheless, in some instances, scanning-based systems may also come with drawbacks. For example, a scanning-based system may only collect specular and diffuse scattered light reflected from a user's eye, which may not necessarily facilitate tracking accuracy and precision. Also, implementation of scanning-based systems may come with limited field-of-view (FOV), limited resolution, and incident angle-caused field distortion.

In some examples, to implement eye-tracking, display devices may implement micro-electromechanical systems (MEMS). For example, in some instances, a micro-electromechanical system (MEMS) may be provided to utilize light beam (e.g., laser) scanning to implement eye-tracking and/or gaze-tracking.

In some instances, implementing scanning technologies via use of a micro-electromechanical systems (MEMS) may provide various advantages. For example, a micro-electromechanical system (MEMS) may enable dynamic controlling of light beam intensity. Furthermore, for example, a micro-electromechanical system (MEMS) may enable a conveniently small physical form factor (e.g., in size, weight, etc.). These advantages may be crucial in enabling inconspicuous, low-profile eye-tracking solutions.

Accordingly, it may be beneficial to provide optical resolution and an expanded field-of-view (FOV) for a scanning-based (micro-electromechanical (MEMS)) system, without increasing form factor and incidence angle-caused obliquity. Systems and methods as described may be directed to, among other things, enhancing eye-tracking speed and resolution in display systems. In some examples and as will be discussed further below, the systems and methods may, among other things, form a three-dimensional (3D) image a user's eye by illuminating the user's eye, measure a distance to a feature (e.g., a user's pupil), and measure a field-of-view (FOV).

In some examples, the systems and methods may provide a display system including an afocal fisheye lens and a micro-electromechanical systems (MEMS) mirror. In some examples, the micro-electromechanical systems (MEMS) mirror may be disposed at a lens stop position and may be movable.

In some examples, an incident light beam may propagate toward and through the fisheye lens in a first direction, reflect off of a (movable) micro-electromechanical systems (MEMS) mirror, and (back) out of the fisheye lens in a second direction, thereby extending a length of an optical path for the display system. As such, in some instances, the systems and methods described may be referred to as implementing a “double-pass” system, and may be utilized to reduce form factor in optical devices.

In some examples, to measure a distance (also referred to as “axial distance” or “depth”) to a target, a time-of-arrival of emitted photons may be measured via a phase change of a returning light beam. In some examples, the target may be a human eye and its vicinity. For example, in some instance, modulation of a light beam at two (2) gigahertz (GHz) frequency may yield a total length for a modulation period to be fifteen (15) centimeters (cm) in the space domain over two phase changes. Moreover, by way of particular example in which a three-dimensional (3D) profile of a user's eye has a feature size of two (2) millimeters (mm), the induced phase change in the reflected beam may be zero point zero eight (0.08) radian (rad), or four point six degrees (4.6°) within 2π.

Also, in some examples, to measure a field-of-view (FOV), an angular position of a scanning-based element (e.g., a micro-electromechanical systems (MEMS) element) may be measured in pitch-and-yaw, which may enable measuring of two lateral dimensions. So, in some examples, for a lateral direction, a micro-electromechanical systems (MEMS) tilt by plus or minus (+) seven and one-half degree (7.5°) may result in a field-of-illumination of plus or minus (+) sixty degrees (60°) x sixty degrees (60°), or an equivalent field-of-view (FOV) of one-hundred twenty degrees (120°).

Moreover, in some examples, the systems and methods disclosed herein may cause minimal or no obliquity to result, as a light beam may (typically) be incident on a micro-electromechanical systems (MEMS) mirror with a small angle. So, in some examples and as will be discussed further below, a collimated, “incident” light beam may pass through a lens (e.g., an afocal fisheye lens), reflect off a micro-electromechanical systems (MEMS) mirror, and subsequently propagate in reverse and exit through the lens (as an “exitance” light beam) towards (or focused on) a target that may be anywhere within a field-of-view (FOV) of a scanning-based optical system having a micro-electromechanical (MEMS) system.

It may be appreciated that an exitance light beam may directed anywhere in a field-of-view (FOV) of a scanning-based optical system having a micro-electromechanical system (MEMS) depending on, among other things, an incidence vector of an incident light beam and a position of a (movable) micro-electronical systems (MEMS) mirror. In some examples, the aperture of an exitance light beam may be equal to an aperture of an incident light beam. Also, in some examples, an incidence light beam and exitance light beam may both be collimated.

In some examples, the systems and methods described herein may provide an eye tracking system for an augmented reality (AR)/virtual reality (VR) display device, the eye tracking system, include a light source to emanate an incident light beam in a first direction, a fisheye lens to propagate the incident light beam in the first direction, and a micro-electromechanical systems (MEMS) mirror to reflect the incident light beam in a second direction, where the incident light beam propagates back through and may exit the fisheye lens towards a target. In some examples, the micro-electromechanical systems (MEMS) mirror may be movable, and the fisheye lens may an afocal fisheye lens, and the afocal fisheye lens may include a back lens group and a front lens group. Also, in some examples, the back lens group and the front lens group may expand the incident light beam to have a larger aperture, and in other examples, the eye tracking system may include a micro-electromechanical systems (MEMS) protective window.

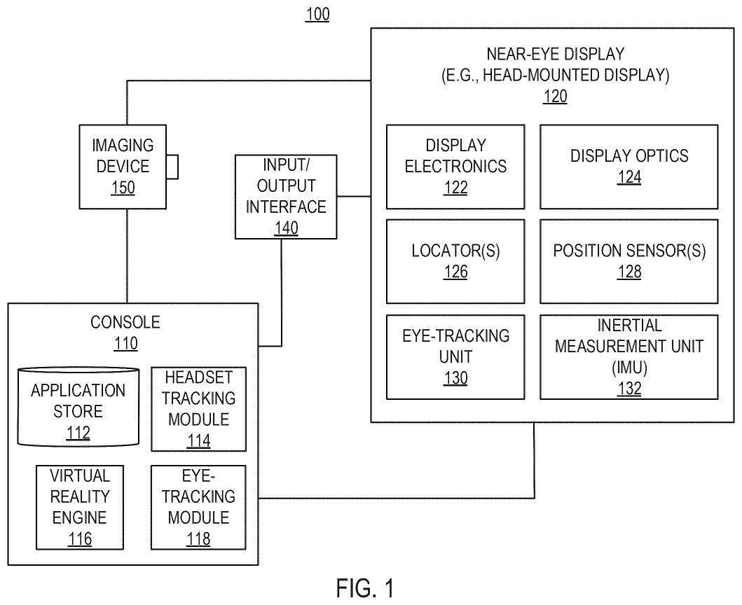

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

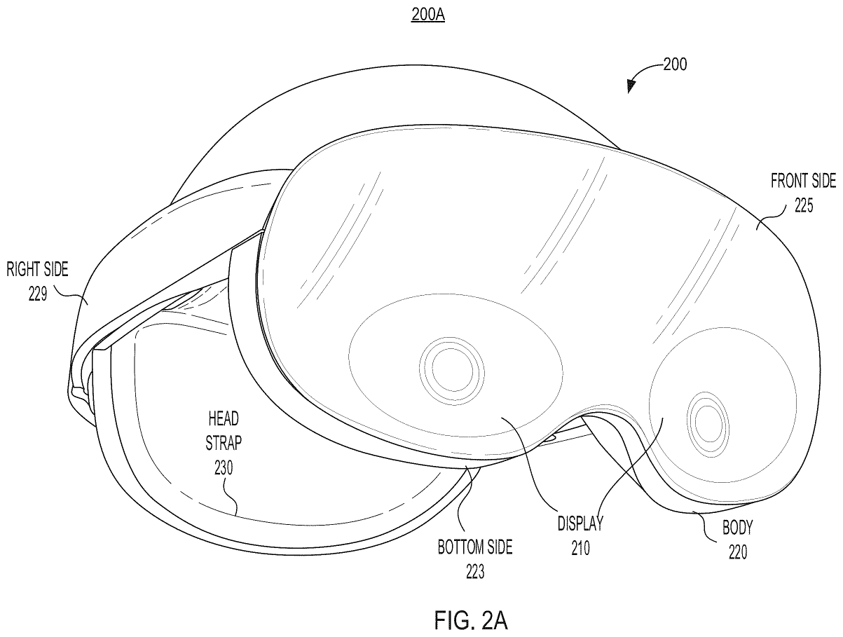

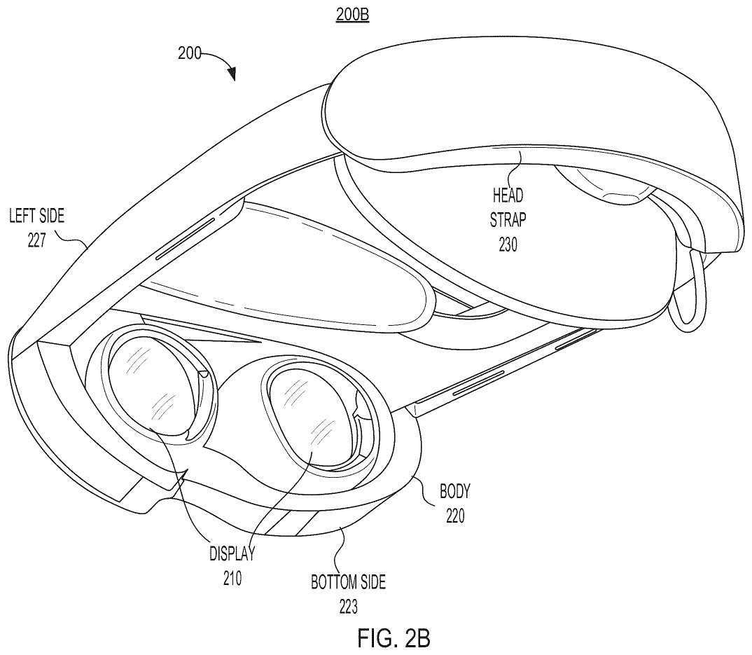

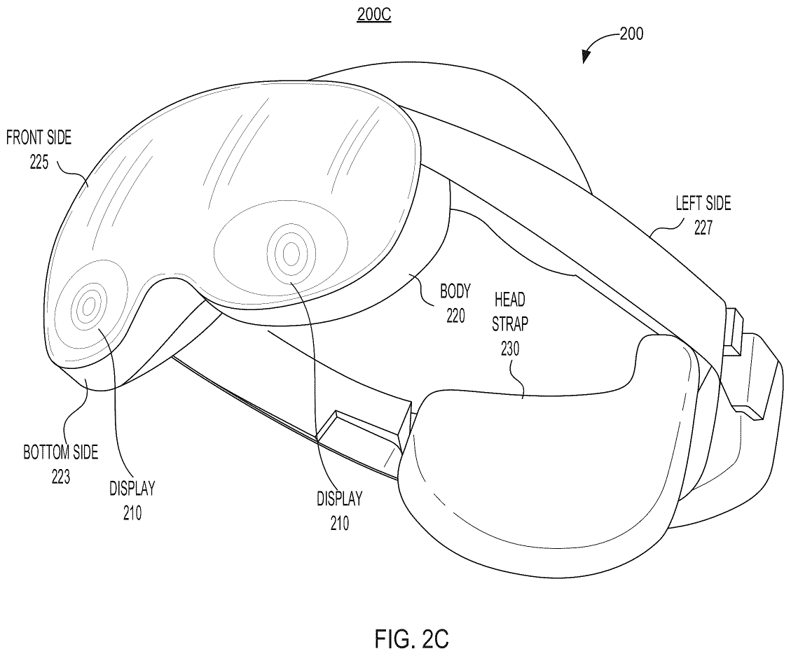

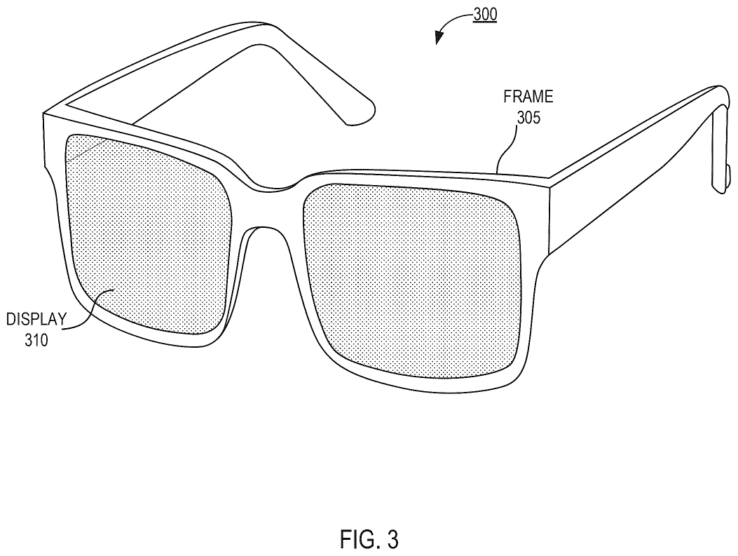

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye tracking unit 130. In some examples, the near-eye display 120 may also include one or more locators 126, one or more position sensors 128, and an inertial measurement unit (IMU) 132. In some examples, the near-eye display 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in angular domain for direct observation by a viewer's eye through a pupil. The projector may employ a controllable light source (e.g., a laser) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may also be designed to correct one or more types of optical aberrations. As used herein, an “optical aberration” may include, among other things, any error incurred in optical propagation. Examples of such optical aberrations include, but are not limited to, defocus, wedge, field curvature, distortion (e.g. pincushion and barrel), and longitudinal and transverse chromatic aberration.

In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube deflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern) that is directed to an eye such that light reflected by the eye may be captured by the imaging system (e.g., a camera).

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from at least one of external imaging device 150, the near-eye display 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display 120 for presentation to the user.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

As discussed herein, the systems and methods may reconstruct an image of a user's eye via implementation of a double-pass field-of-view (FOV) expander for a micro-electromechanical systems (MEMS)-based scanning system. In some examples, the double-pass field-of-view (FOV) expander may be implemented in at least one of the components of the near-eye display 100 illustrated in FIG. 1. For example, in some instances, the eye-tracking unit 130 may implement a light source that may a collimated, “incident” light beam may pass through a lens (e.g., an afocal fisheye lens), reflect off a micro-electromechanical systems (MEMS) mirror, and subsequently propagate (back) and exit through the lens (as an “exitance” light beam) towards (or focused on) a target that may be anywhere within a field-of-view (FOV) of a display device. In some examples, the target may be a human eye and its vicinity. Accordingly, in some examples, the eye-tracking unit 130 may implement the systems and methods described herein to illuminate the user's eye, and may enable in-field sensing technologies that may acquire intensity, depth, velocity, and other useful information for eye-tracking.

FIGS. 2A-2C illustrate various views of a near-eye display device in a form of a head-mounted display (HMD) device 200, according to examples. In some examples, the head-mounted device (HMD) device 200 may be a part of a virtual reality (VR) system, an augmented reality (AR) system, a mixed reality (MR) system, another system that uses displays or wearables, or any combination thereof. As shown in diagram 200A of FIG. 2A, the head-mounted display (HMD) device 200 may include a body 220 and a head strap 230. The front perspective view of the head-mounted display (HMD) device 200 further shows a bottom side 223, a front side 225, and a right side 229 of the body 220. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components such as a display 210 to present a wearer augmented reality (AR)/virtual reality (VR) content and a camera to capture images or videos of the wearer's environment.

As shown in the bottom perspective view of diagram 200B of FIG. 2B, the display 210 may include one or more display assemblies and present, to a user (wearer), media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the user may interact with the presented images or videos through eye tracking sensors enclosed in the body 220 of the head-mounted display (HMD) device 200. The eye tracking sensors may also be used to adjust and improve quality of the presented content.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface for communicating with a console communicatively coupled to the head-mounted display (HMD) device 200 through wired or wireless means. In some examples, the head-mounted display (HMD) device 200 may include a virtual reality engine (not shown) that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine may be used for producing a signal (e.g., display instructions) to the display 210. In some examples, the head-mounted display (HMD) device 200 may include locators (not shown), which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped like eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

In some examples, an in-field scanning system for eye-tracking may be implemented in the head-mounted display (HMD) device 200. Hardware (and software) elements may be utilized to gather end-to-end knowledge of a current state of the head-mounted display (HMD) device 200, and implement a double-pass field-of-view (FOV) expander for a micro-electromechanical systems (MEMS)-based scanning system to reconstruct an image of a user's eye. As the head-mounted display (HMD) device 200 state may change, the systems and methods described may periodically reconfigure the aspect and states of individual subsystems illustrated in FIGS. 2A-2C to enable the in-field scanning.

FIG. 3 is a perspective view of a near-eye display 300 in the form of a pair of glasses (or other similar eyewear), according to an example. In some examples, the near-eye display 300 may be a specific example of near-eye display 120 of FIG. 1 and may be configured to operate as a virtual reality display, an augmented reality (AR) display, and/or a mixed reality (MR) display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1 and 2A-2C. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 310 may include a projector, or in place of the display 310 the near-eye display 300 may include a projector.

In some examples, the near-eye display 300 may further include various sensors on or within a frame 305. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors may also be used for stereoscopic imaging or other similar applications.

In some examples, a double-pass field-of-view (FOV) expander for a micro-electromechanical systems (MEMS)-based scanning system having an afocal fisheye lens and a movable micro-electromechanical systems (MEMS) mirror as described herein may be implemented in the display 310 of the near-eye display 300. For example, in some examples, the double-pass field-of-view (FOV) expander may be located in the display 310, and may receive a light beam emanating from a light source also located in the display 310. In other examples, the double-pass field-of-view (FOV) expander may be located in the display 310, and may receive a light beam emanating from a light source also located in the frame 305. As will be described further below, the double-pass field-of-view (FOV) expander for a micro-electromechanical systems (MEMS)-based scanning system described may be implemented to reconstruct an image of a user's eye. In so doing, in some examples, the integrated micro-electromechanical (MEMS) system may enable a minimal form-factor, in that components may be embedded directly in the display 310 of the near-eye display 300.

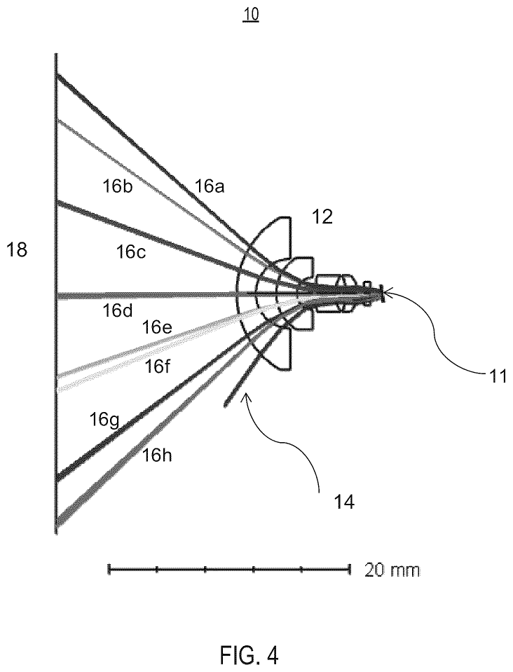

FIG. 4 illustrates a display system 10 having an afocal fisheye lens 12 with a micro-electromechanical systems (MEMS) mirror 11, according to an example. As will be discussed in further detail, in some examples, the micro-electromechanical systems (MEMS) mirror 11 may be movably disposed at various positions and angles to receive an incident light beam and reflect variously-angled light beams. In some examples, the movable micro-electromechanical systems (MEMS) mirror 11 may be placed at one or more lens stop positions.

In some examples, an incident light beam 14 (e.g., produced by an illumination source (not shown)) may be directed to the afocal fisheye lens 12, may reflect off the (movable) micro-electromechanical systems (MEMS) mirror 11, and may exit the afocal fisheye lens 12 as one of exitance light beams 16a-16h towards a target 18. That is, in some examples, as a position of a micro-electromechanical systems (MEMS) mirror may move (e.g., pivoted over an angular range), the micro-electromechanical systems (MEMS) mirror may produce at least one of the exitance light beams 16a-16h.

In some examples, the exitance light beams 16a-16b may be directed within the field-of-view (FOV) of the display system 10, depending on an incidence vector of the incident light beam 14 and an angular position of the micro-electromechanical systems (MEMS) mirror 11. Accordingly, in some examples, the exitance light beams 16a-16h produced via the afocal fisheye lens 12 and the micro-electromechanical systems (MEMS) mirror 11 may be utilized to scan a substantial portion or all of a field-of-view (FOV). For example, the exitance light beams 16a-16h may be utilized to scan for a particular target in the field-of-view (FOV), such as a device user's eye and its environs.

In some examples, and as will be discussed in further detail below, the afocal fisheye lens 12 may enable angular amplification. In some examples, as the micro-electromechanical systems (MEMS) mirror 11 may have a particular and/or predetermined degree of freedom (e.g., seven and one-half degrees (7.5°), this angular amplification may thereby be increased significantly. In some examples, providing the aforementioned angular amplification may enable scanning a broad (er) field-of-view (FOV). Indeed, in some examples, the scanned field-of-view (FOV) of the afocal fisheye lens 12 may (typically) be broader than a scanning angle of, for example, a micro-electromechanical systems (MEMS) mirror. Furthermore, it may be appreciated that this angular amplification may be provided with minimal increase in form factor of an associated display device. Accordingly, in some examples, the afocal fisheye lens 12 may operate in conjunction with the micro-electromechanical systems (MEMS) mirror 11 to increase an optical path traveled by the incident light beam 14.

Furthermore, it may be appreciated that while the aforementioned examples may relate to (single) incident light beam 14, in other examples, a plurality of incident light beams may be propagated through the afocal fisheye lens 12, reflected off the (movable) micro-electromechanical systems (MEMS) mirror 11, and directed out of the afocal fisheye lens 12 to scan over multiple angles in the field-of-view (FOV). Furthermore, it may also be appreciated that the plurality of incident light beams may be time-interleaved and aimed (or directed) in similar (e.g., separated by one (1) to five (5) angular degrees) or identical directions (i.e., “co-propagation”), so as to effectively and efficiently scan the field-of-view (FOV) (e.g., thereby facilitating implementation of a higher “probe-rate”). In addition, in some examples, the plurality of incident light beams may possess a plurality of wavelengths, and during propagation, may be united to a single beam as well.

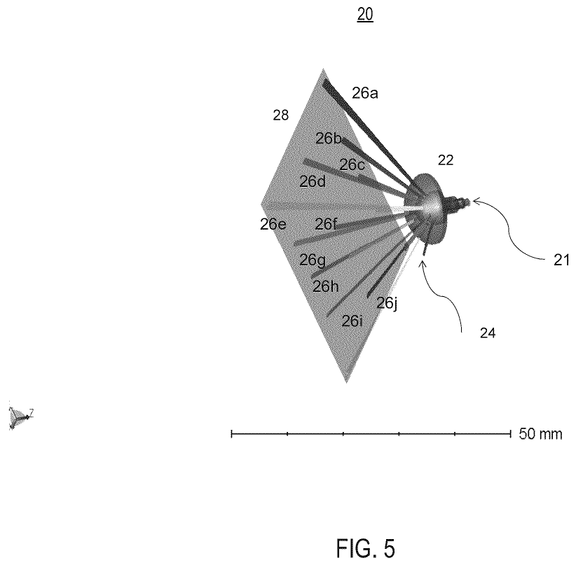

FIG. 5 illustrates a display system 20 having an afocal fisheye lens 22 with a micro-electromechanical systems (MEMS) mirror 21, according to an example. In some examples, the micro-electromechanical systems (MEMS) mirror 21 may be movable. In particular, in some examples, the micro-electromechanical systems (MEMS) mirror 21 may be movable to enable the micro-electromechanical systems (MEMS) mirror 21 to be inclined at various angles.

As a result, in some examples, an incident light beam 24 may be emanated by a light source (not shown), and may be propagated toward the afocal fisheye lens 22. In some examples, the incident light beam 24 may reflect off the (movable) micro-electromechanical systems (MEMS) mirror 21, and may exit the afocal fisheye lens 22 as one of the exitance light beams 26a-26j towards a target 28. In some examples, a distance from the micro-electromechanical systems (MEMS) mirror 21 to the target 28 may be approximately fifty (50) millimeters (mm).

In some examples, and as will be discussed further below, the afocal fisheye lens 22 may include one or more lenses. For example, in some instances, the afocal fisheye lens 22 may include, among other types of lenses, a fisheye lens and an eye-piece relay lens. In some examples, the afocal fisheye lens 22 may be utilized to expand an incident (e.g., collimated) light beam to make an exitance (reflected) light beam larger in aperture (e.g., to provide broader field-of-view), while nevertheless also maintaining its collimated and afocal properties as it may reflect off the micro-electromechanical systems (MEMS) mirror 21.

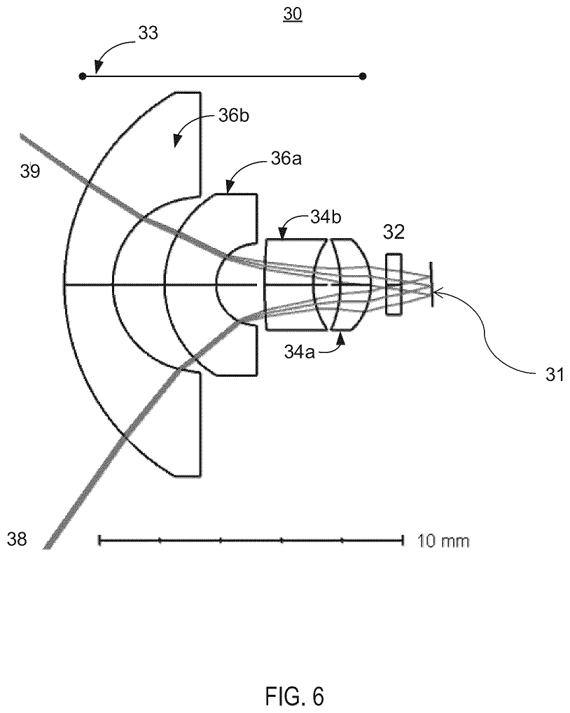

FIG. 6 illustrates a display system 30 having an afocal fisheye lens 33 with a micro-electromechanical systems (MEMS) mirror 31, according to an example. In some examples, the afocal fisheye lens 33 may include, among other things, a back lens group 34a, 34b and a front lens group 36a, 36b. In some examples, a distance from the micro-electromechanical systems (MEMS) mirror 31 to the (outer) front lens 36b may be approximately ten (10) millimeters (mm).

In some examples, an incident light beam 38 (e.g., produced by an illumination source (not shown)) may be directed to and propagate through the afocal fisheye lens 33. In particular, in the example illustrated in FIG. 6, the incident light beam 38 may be directed toward the front lens group 36a, 36b and may propagate through the back lens 34a, 34b towards a micro-electromechanical systems (MEMS) protective window 32 (i.e., to protect the micro-electromechanical systems (MEMS) mirror 31), and further toward the micro-electromechanical systems (MEMS) mirror 31. In some examples, while propagating towards the micro-electromechanical systems (MEMS) mirror 31, the back lens group 34a, 34b and the front lens group 36a, 36b may expand the incident light beam 38 to make the incident light beam 38 larger in aperture.

In some examples, the micro-electromechanical systems (MEMS) mirror 31 may be placed in a lens stop position. In some examples, the micro-electromechanical systems (MEMS) mirror 30 may be movable, and the incident light beam 38 may variably reflect off the (movable) micro-electromechanical systems (MEMS) mirror 30, as discussed above. As used herein, “variably” reflecting may include reflecting in a variety of directions (e.g., according to the movement of the micro-electromechanical systems (MEMS) mirror). In particular, in some examples, the micro-electromechanical systems (MEMS) mirror 30 may be movable to enable the micro-electromechanical systems (MEMS) mirror 30 to be inclined at various angles so as to generate an exitance angle for the exitance light beam 39 that may be different that the incidence angle of the incident light beam 38.

Upon reflecting off the (movable) micro-electromechanical systems (MEMS) mirror 30, the incident light beam 38 may propagate (e.g., in a reverse direction) through the back lens group 34a, 34b and the front lens group 36a, 36b. In particular, in some examples, the back lens group 34a, 34b and the front lens group 36a, 36b may narrow (or circumscribe) an aperture of the incident light beam 38. In some examples, the incident light beam 38 may then exit the afocal fisheye lens 33 as an exitance light beam 39 heading towards a target (e.g., a display lens).

In some examples, the exitance light beam 39 may be directed anywhere within a given field-of-view (FOV) of a display device, depending on incidence characteristics of the incident light beam 38 and the reflective (e.g., positional) characteristics of the micro-electromechanical systems (MEMS) mirror 30. Moreover, in some examples, an aperture of the incident light beam 38 may equal an aperture of the exitance light beam 39. Furthermore, in some examples, minimal or even no obliquity may be caused during operation, as the incidence angle of incident light beam 38 may (typically) be minimal.

In some examples, at least one of the back lens group 34a, 34b and the front lens group 36a, 36b may be compound lenses, and may include positive and/or negative lenses. In particular, in some examples, the back lens group 34a, 34b and the front lens group 36a, 36b may include a meniscus lens that may be convex or concave in shape. In some examples, one or more lenses in included in the back lens group 34a, 34b and front lens group 36a, 36b may be composed of crown glass or flint glass, and may have lower refractive indexes (e.g., between one-point four (1.4) and two-point one (2.1)). It may be appreciated that the example illustrated in FIG. 5 may be one example of an afocal fisheye lens 33, and that in other examples, any number of lens, lens types (e.g., concave, convex), lens properties (e.g., positive, negative) may be implemented, depending on the circumstances (e.g., as may be appropriate to produce a (collimated) exitance light beam 39).

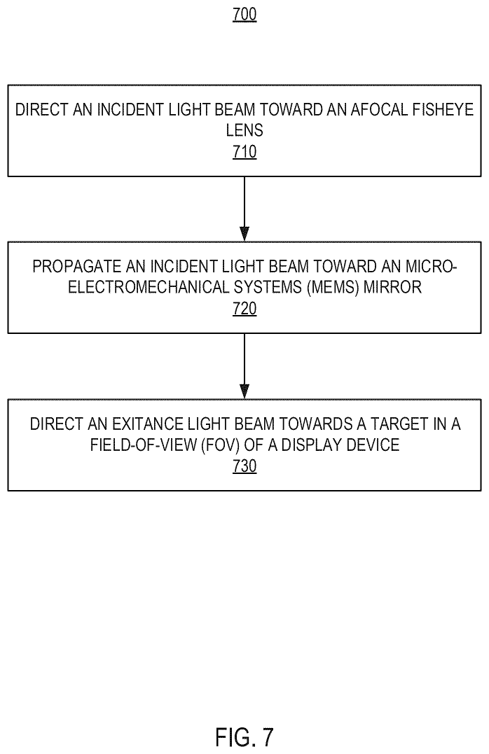

FIG. 7 illustrates a method for implementing a display system having an afocal fisheye lens with a micro-electromechanical system (MEMS) mirror, according to an example. The method 700 is provided by way of example, as there may be a variety of ways to carry out the method described herein. The method 700 may be executed or otherwise performed by one or more processing components of another system or a combination of systems. Each block shown in FIG. 7 may further represent one or more processes, methods, or subroutines, and at least one of the blocks (e.g., the selection process) may include machine readable instructions stored on a non-transitory computer readable medium and executed by a processor or other type of processing circuit to perform one or more operations described herein.

At 710, an illumination source may emanate an incident light beam toward an afocal fisheye lens. In some examples, the afocal fisheye lens may include, among other things, a back lens group and a front lens group. In some examples, the back lens group and the front lens group may expand the incident light beam to make the incident light beam larger in aperture.

At 720, a light beam may be propagated through an afocal fisheye lens toward a micro-electromechanical systems (MEMS) mirror. In some examples, the micro-electromechanical systems (MEMS) mirror may operate in conjunction with a micro-electromechanical systems (MEMS) protective window. In some examples, the micro-electromechanical systems (MEMS) mirror may be movable to enable the micro-electromechanical systems (MEMS) mirror to be inclined at various angles so as to generate an exitance angle for the exitance light beam that may be different than an incidence angle of the incident light beam.

At 730, a reflected incidence light beam may be propagated through an afocal fisheye lens as an exitance light beam towards a target. In particular, in some examples, the exitance light beam may be directed anywhere within a field-of-view (FOV) of a display device, depending on incidence characteristics of the incident light beam and the reflective (e.g., positional) characteristics of the micro-electromechanical systems (MEMS) mirror.

According to examples, a method of making a double-pass field-of-view (FOV) expander is described herein. A system of making the double-pass field-of-view (FOV) expander is also described herein. A non-transitory computer-readable storage medium may have an executable stored thereon, which when executed instructs a processor to perform the methods described herein.

In some examples, the systems and methods described herein may include an eye tracking system for an augmented reality (AR)/virtual reality (VR) display device, the eye tracking system, comprising a light source to emit an incident light beam in a first direction, a fisheye lens to propagate the incident light beam in the first direction, and a micro-electromechanical systems (MEMS) mirror to pivot from a first position to a second position to reflect the incident light beam in a second direction to enable angular amplification and scanning of a field-of-view (FOV). In some examples, the incident light beam propagates back through and exits the fisheye lens towards a target, the fisheye lens is an afocal fisheye lens, and the afocal fisheye lens comprises a back lens group and a front lens group, the back lens group and the front lens group expand the incident light beam to make the incident light beam larger in aperture, and the back lens group and the front lens group narrow the incident light beam to make the incident light beam smaller in aperture. In some examples, a distance from the MEMS mirror to an outer front lens of the front lens group may be approximately ten (10) millimeters (mm), at least one of the back lens group and the front lens group include a meniscus lens, the MEMS mirror is pivoted over a predetermined degree of freedom, and the predetermined degree of freedom is seven and one-half degrees (7.5°). Furthermore, in some examples, the eye tracking system may further comprise a MEMS protective window, the incident light beam is included in a plurality of incident light beams propagated towards the MEMS mirror, and the plurality of incident light beams propagated towards the MEMS mirror are time-interleaved and directed in similar directions to enable scanning of the FOV.

In some examples, the systems and methods may include a method for eye tracking system in an augmented reality (AR)/virtual reality (VR) display device, comprising emitting an incident light beam in a first direction, propagating, via an afocal fisheye lens, the incident light beam in the first direction towards a micro-electromechanical systems (MEMS) mirror, and pivoting the MEMS mirror from a first position to a second position to reflect the incident light beam in a second direction to enable angular amplification and scanning of a field-of-view (FOV). In some examples, the method may include propagating the incident light beam away from the MEMS mirror in the second direction towards a target, the afocal fisheye lens includes a back lens group and a front lens group. In some examples, in propagating the incident light towards the MEMS mirror, the back lens group and the front lens group expand the incident light beam to make the incident light beam larger in aperture, and in propagating the incident light beam away from the MEMS mirror, the back lens group and the front lens group narrow the incident light beam to make the incident light beam smaller in aperture.

In some examples, the systems and methods may include a non-transitory computer readable medium configured to store program code instructions, when executed by a processor, cause the processor to perform steps comprising emit an incident light beam in a first direction, propagate, via an afocal fisheye lens, the incident light beam in the first direction towards a micro-electromechanical systems (MEMS) mirror, and pivot the MEMS mirror from a first position to a second position to reflect the incident light beam in a second direction to enable angular amplification and scanning of a field-of-view (FOV). In some examples, the instructions, when executed by the processor, cause the processor to pivot the MEMS mirror over a predetermined degree of freedom, and the incident light beam is included in a plurality of incident light beams propagated towards the MEMS mirror, and where the plurality of incident light beams propagated towards the MEMS mirror are time-interleaved and directed in similar directions to enable scanning of the FOV.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example′ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An eye tracking system for an augmented reality (AR)/virtual reality (VR) display device, the eye tracking system, comprising:
a light source to emit an incident light beam in a first direction;
a fisheye lens to propagate the incident light beam in the first direction; and
a micro-electromechanical systems (MEMS) mirror to pivot from a first position to a second position to reflect the incident light beam in a second direction to enable angular amplification and scanning of a field-of-view (FOV).

2. The eye tracking system of claim 1, wherein the incident light beam propagates back through and exits the fisheye lens towards a target.

3. The eye tracking system of claim 1, wherein the fisheye lens is an afocal fisheye lens, and the afocal fisheye lens comprises a back lens group and a front lens group.

4. The eye tracking system of claim 3, wherein the back lens group and the front lens group expand the incident light beam to make the incident light beam larger in aperture.

5. The eye tracking system of claim 4, wherein the back lens group and the front lens group narrow the incident light beam to make the incident light beam smaller in aperture.

6. The eye tracking system of claim 3, wherein a distance from the MEMS mirror to an outer front lens of the front lens group may be approximately ten (10) millimeters (mm).

7. The eye tracking system of claim 3, wherein at least one of the back lens group and the front lens group include a meniscus lens.

8. The eye tracking system of claim 1, wherein the MEMS mirror is pivoted over a predetermined degree of freedom.

9. The eye tracking system of claim 8, wherein the predetermined degree of freedom is seven and one-half degrees (7.5°).

10. The eye tracking system of claim 1, further comprising a MEMS protective window.

11. The eye tracking system of claim 1, wherein the incident light beam is included in a plurality of incident light beams propagated towards the MEMS mirror.

12. The eye tracking system of claim 11, wherein the plurality of incident light beams propagated towards the MEMS mirror are time-interleaved and directed in similar directions to enable scanning of the FOV.

13. A method for eye tracking system in an augmented reality (AR)/virtual reality (VR) display device, comprising:
emitting an incident light beam in a first direction;
propagating, via an afocal fisheye lens, the incident light beam in the first direction towards a micro-electromechanical systems (MEMS) mirror; and
pivoting the MEMS mirror from a first position to a second position to reflect the incident light beam in a second direction to enable angular amplification and scanning of a field-of-view (FOV).

14. The method of claim 13, further comprising propagating the incident light beam away from the MEMS mirror in the second direction towards a target.

15. The method of claim 14, wherein the afocal fisheye lens includes a back lens group and a front lens group.

16. The method of claim 15, wherein in propagating the incident light towards the MEMS mirror, the back lens group and the front lens group expand the incident light beam to make the incident light beam larger in aperture.

17. The method of claim 16, wherein in propagating the incident light beam away from the MEMS mirror, the back lens group and the front lens group narrow the incident light beam to make the incident light beam smaller in aperture.

18. A non-transitory computer readable medium configured to store program code instructions, when executed by a processor, cause the processor to perform steps comprising:
emit an incident light beam in a first direction;
propagate, via an afocal fisheye lens, the incident light beam in the first direction towards a micro-electromechanical systems (MEMS) mirror; and
pivot the MEMS mirror from a first position to a second position to reflect the incident light beam in a second direction to enable angular amplification and scanning of a field-of-view (FOV).

19. The non-transitory computer readable medium of claim 18, wherein the instructions, when executed by the processor, cause the processor to pivot the MEMS mirror over a predetermined degree of freedom.

20. The non-transitory computer readable medium of claim 18, wherein the incident light beam is included in a plurality of incident light beams propagated towards the MEMS mirror, and wherein the plurality of incident light beams propagated towards the MEMS mirror are time-interleaved and directed in similar directions to enable scanning of the FOV.
